(19) United States
(12) Patent Application Publication
(10) Pub. No.: US 2025/0111086 A1
(43) Pub. Date: Apr. 3, 2025

(54) ELECTRONIC DEVICE THAT SELECTIVELY PRESENTS AN ANONYMIZED IMAGE VERSION OF AN IMAGE SOURCED FROM THE DEVICE ON A SECONDARY DISPLAY CONNECTED TO THE DEVICE

(71) Applicant: MOTOROLA MOBILITY LLC, WILMINGTON, DE (US)

(72) Inventors: AMIT KUMAR AGRAWAL, BANGALORE (IN); BOBY IYER, ELMHURST, IL (US); BENICIO PEREIRA GOULART, CAMPINAS (BR)

(21) Appl. No.: 18/476,891

(22) Filed: Sep. 28, 2023

(51) Int. Cl. G06F 21/62; G06T 5/00; G06T 7/10; G06V 40/16

(52) U.S. Cl. CPC G06F 21/6254; G06T 5/77; G06T 7/10; G06V 40/172; G06V 2201/07

(57) ABSTRACT

An electronic device, method and computer program product enables sharing of photographic image(s) that anonymize people contained in the photographic image(s). The electronic device includes first integrated display(s). The electronic device includes a memory that stores photographic image(s). The electronic device includes a communications subsystem configurable to connect the electronic device to second device(s) having second display(s). A controller of the electronic device presents, to an authorized user of the electronic device, the photographic image(s) on first integrated display(s). In response to a trigger to present the photographic image(s) on the second display(s) while an image display function of the electronic device is set to a privacy mode. The controller recognizes human subject(s) in the photographic image(s). The controller anonymizes the human subject(s) in a private mode version of the photographic image(s). The controller presents the private mode version of the photographic images on the second display(s).

### BACKGROUND

### 1. Technical Field

The present disclosure relates generally to electronic devices that present and transmit photographic images, and in particular to electronic devices that present, modify, and transmit photographic images.

### 2. Description of the Related Art

Portable electronic communication devices, particularly smartphones, have become ubiquitous. People all over the world use such devices to stay connected. With incorporation of graphical displays and cameras, mobile devices are used frequently for capturing and replaying visual content such as photographic images and video recordings. These dual display devices can also be used for sharing the photographic images with another person located on a back side of the device viewing the back display. In some situations, the owner (or an authenticated user) of the electronic device may have photographic images stored on the device and which include image content that the user would prefer to not share with others. The user has to undertake a number of manual user actions prior to the time of sharing to avoid the inadvertent sharing of these images and/or image content, while sharing other publicly sharable images and/or content.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram and three-dimensional views of a communication device presenting a private version of a photographic image and sending an anonymized version of the photographic image to a second device, according to one or more embodiments;

FIG. 2A is a diagram of the communication device presenting the private version of the photographic image while sending the anonymized version of the photographic image to the secondary display of the second device via wireless or wired connection, according to one or more embodiments;

FIG. 2B is a diagram of the communication device presenting the private version of photographic image(s) while sending anonymized photographic image(s) over a communication environment to the second device, according to one or more embodiments;

FIG. 2C is a diagram of the communication device presenting the private version of photographic image(s) while sending anonymized photographic image(s) over a communication environment to a social media system that is accessible by the second device, according to one or more embodiments;

FIGS. 3A-3D (collectively “FIG. 3”) are a flow diagram presenting a method of for automatically generating anonymized versions of photographic image(s) that are being shared for presentation on a secondary device, according to one or more embodiments; and

FIG. 4 is a flow diagram presenting a method or automatically anonymizing photographic images, by an electronic device, that are shared with a second electronic device via a media sharing network.

### DETAILED DESCRIPTION

According to aspects of the present disclosure, an electronic device, a method, and a computer program product enables presenting or sharing of photographic image(s) that anonymize people contained in the photographic image(s), while also presenting an original version to an authorized user of the electronic device. The electronic device includes at least one first integrated display. The electronic device includes a memory that stores one or more photographic images. The electronic device includes a communications subsystem configurable to connect the electronic device to one or more second devices having at least one second display. A controller of the electronic device is communicatively connected to the memory and the communications subsystem. The controller presents, to an authorized user of the electronic device, the one or more photographic images on a first integrated display of the at least one first integrated display. In response to a trigger to present the one or more photographic images on a second display of the at least one second display while an image display function of the electronic device is set to a privacy mode, the controller recognizes one or more human subjects in the one or more photographic images. The controller anonymizes the one or more human subjects in a private mode version of the one or more photographic images. The controller presents the private mode version of the one or more photographic images on the second display.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

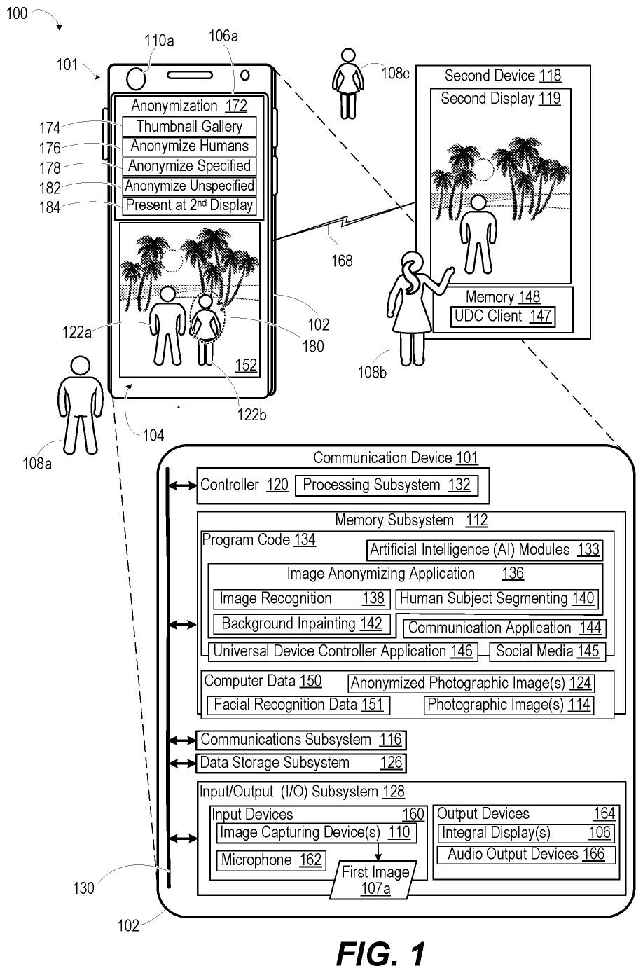

FIG. 1 presents a simplified functional block diagram of an electronic device that present a private version of a photographic image on integral display(s) while sending an anonymized version of the photographic image to a secondary display. In one or more embodiments, the electronic device includes additional communications functionality as communication device 101 to operate as a mobile user device in communication environment 100. Communication device 101 can be one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices.

In one or more embodiments, communication device 101 includes device housing 102 having first side 104 (e.g., a front side). Communication device 101 has integrated first display(s) 106 that includes first integrated display 106a exposed on first side 104 for viewing by first person 108a, who is an authorized user of communication device 101. Communication device 101 may have image capturing device(s) 110 that includes first image capturing device 110a exposed on first side 104 of device housing 102. When first person 108a is viewing first integrated display 106a, first person 108a may be within a field of view of first image capturing device 110a. Communication device 101 includes memory subsystem 112 that stores photographic image(s) 114. Communications device 101 includes communications subsystem 116 that is configurable to connect communication device 101 to second device(s) 118 having second display(s) 119, which may be viewed by second person 108b. Controller 120 of communication device 101 is communicatively coupled to integrated first display(s) 106, image capturing device(s) 110, memory subsystem 112, and communications subsystem 116. In response to a trigger to present photographic image(s) 114 on second display(s) 119 while an image display function of communication device 101 is set to a privacy mode, controller 120 recognizes human subjects 122a and 122b in photographic image(s) 114 at least as humans for anonymizing. In one or more embodiments, controller 120 may individually identify one or more human subjects 122a-122b in photographic image(s) 114 for selectively anonymizing. In an example, human subject 122a is an image of first person 108a and human subject 122b is an image of third person 108c. Human subject 122b identified as third person 108c is anonymized and human subject 122a not identified as third person 108c is not identified. In one or more embodiments, identification may be used to identify human subjects that are to be affirmatively included. Alternatively, or in addition, identification may be used to identify human subjects that to anonymized. Controller 120 anonymizes one or more human subjects 122a-122b in a private mode version (“anonymized photographic image(s)” 124) of photographic image(s) 114. Controller 120 either directly presents or indirectly enables presentation of the private mode version (anonymized photographic image(s) 124) of photographic image(s) 114 on second display(s) 119.

Communication device 101 may further include data storage subsystem 126 and input/output (I/O) subsystem 128. To enable management by controller 120, system interlink 130 communicatively connects controller 120 with memory subsystem 112, communications subsystem 116, data storage subsystem 126 and I/O subsystem 128. System interlink 130 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 130) are illustrated in FIG. 1, it is to be understood that more, fewer, or different interconnections may be present in other embodiments.

Controller 120 includes processor subsystem 132, which includes one or more central processing units (CPUs) or data processors. Processor subsystem 132 can include one or more digital signal processors that can be integrated with data processor(s). Processor subsystem 132 can include other processors such as auxiliary processor(s) that may act as a low power consumption, always-on sensor hub for physical sensors. Controller 120 manages, and in some instances directly controls, the various functions and/or operations of communication device 101. These functions and/or operations include, but are not limited to including, application data processing, communication with second communication devices, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Controller 120 may include various functionality that enables controller 120 to perform different aspects of artificial intelligence (AI) modules 133 for computation tasks. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output.

Memory subsystem 112 stores program code 134 for execution by processor subsystem 132 to provide the functionality described herein. Program code 134 includes applications such as image anonymizing application 136 that my incorporate or utilize program code 134 such as image recognition application 138, human subject segmenting application 140, and background inpainting application 142. Processor subsystem 132 executes anonymizing application 136 to configure communication device 101 to accept user interface inputs, supervise anonymization, and direct transmission and deletion of anonymization photographic image(s) 153. Processor subsystem 132 may execute image recognition application 138 to recognize a human shape. Processor subsystem 132 may execute image recognition application 138 to biometrically characterize a newly selected face or to identify a previously characterized face. Processor subsystem 132 executes human subject segmenting application 140 to blur or redact the shape of recognized human shape. Processor subsystem 132 executes background inpainting application 142 to replace the blurred or redacted segments with a new background image based on the surrounding background image. Image anonymizing application 136 may incorporate artificial intelligence (AI) capabilities in being trained to recognize particular types of images. Image anonymizing application 136 may incorporate two dimensional correlations or image matching to identify a human shape.

In addition, program code 134 may include communication application 144 and social media application 145 that facilitate uploading of photographic image(s) 114. These applications may be software or firmware that, when executed by controller 120, configures communication device 101 to provide specific aspects of the functionality described herein. In one or more embodiments, several of the described aspects of the present disclosure are provided via executable program code of applications executed by controller 120. In one or more embodiments, program code 134 may be integrated into a distinct chipset or hardware module as firmware that operates separately from executable program code. Portions of program code 134 may be incorporated into different hardware components that operate in a distributed or collaborative manner. Memory subsystem 112 further includes operating system (OS), firmware interface, such as basic input/output system (BIOS) or Uniform Extensible Firmware Interface (UEFI), and firmware, which also includes and may thus be considered as program code 134.

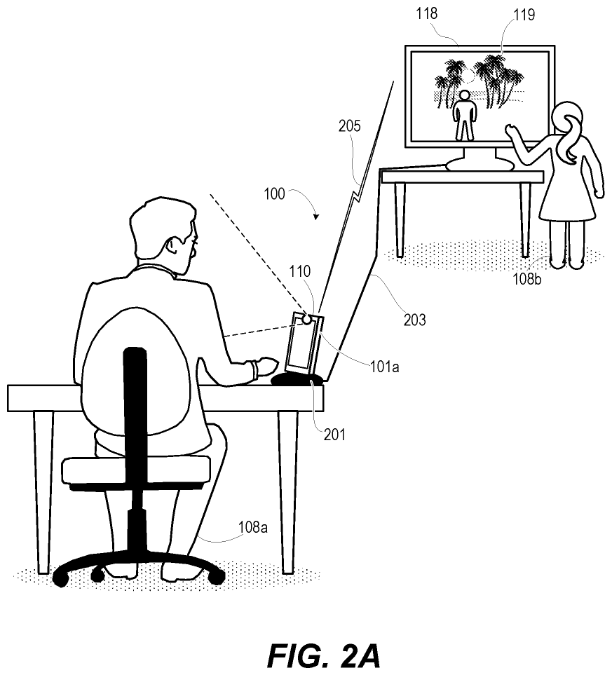

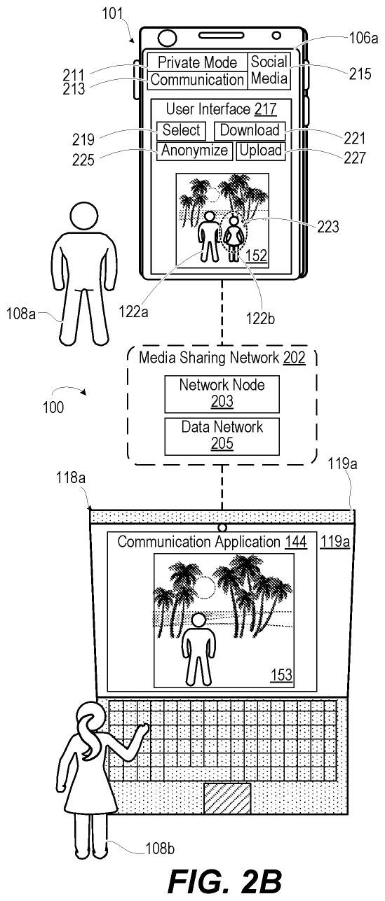

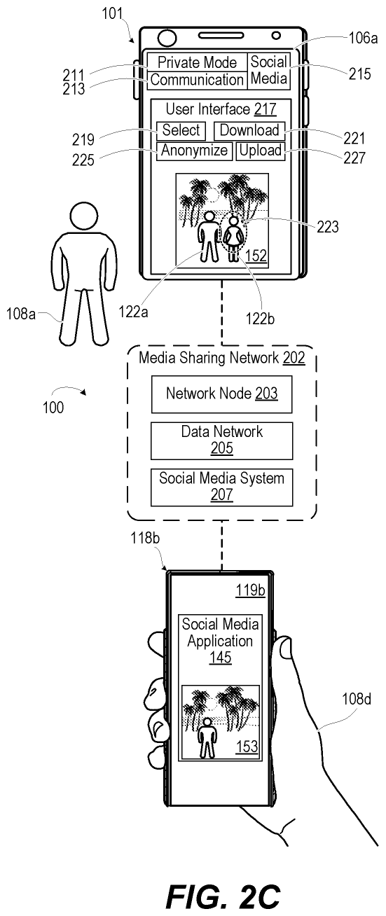

FIG. 2A is a depiction of example communication device 101a implemented as a handheld mobile device that is placed in dock 201. Dock 201 may provide physical positioning of communication device 101 to orient front image capturing device 110 toward first person 108a for authentication by facial recognition. Dock 201 may provide electrical power to communication device 101a. Dock 201 may provide wired network link 203 to second device 118 that presents visual content to second person 108b. Alternatively, communications subsystem 116 of communication device 101a may communicatively connect with second device 118 via wireless link 205. Second device 118 may be a monitor, laptop, desktop workstation, game console, or other electronic device having one or more second displays 119.

Returning to FIG. 1, in one or more embodiments, communication device 101, such as implemented as communication device 101a (FIG. 2A), controls second devices 118 using universal device controller (UDC) technology. UDC technology may be used to interface to consumer electronic devices which respond to external control requests or exposes status information. According to aspects of the present disclosure, UDC technology may provide for remote control of personal electronic devices that have full user interface capabilities of their own unlike simpler consumer electronic device. The UDC technology acts as an intermediary between communication device 101 and slave devices such as second devices 118 that are controlled by communication device 101. In one or more embodiments, memory subsystem 112 of communication device 101 stores universal device controller application 146. Each second device 118 stores universal device controller client application 147 in corresponding second memory subsystem 148. Controller 120 executes universal device controller application 146 to configure communications subsystem 116 to support a communication exchange with second device 118, which executes universal device controller client application 147.

Program code 134 may access, use, generate, modify, store, or communicate computer data 150, such as facial recognition data 151 obtained for example from first image 107a of first person 108a. Computer data 150 includes photographic image(s) 114 that may include human subjects considered to be private and not to be indiscriminately shared. In an example, first person 108a may be captured in photographic image(s) 114 with a third person. First person 108a may select, or image anonymizing application 136 may default to, removing all human subjects 122a-122b from photographic image(s) 114 to generate anonymized photographic image(s) 124 before presenting or sharing to second person 108b. First person 108a may select that only particular human subjects 122a-122b such as third person 108c should be removed from photographic image(s) 114 to generate anonymized photographic image(s) 124 before presenting or sharing to second person 108b. Computer data 150 may incorporate “data” that originated as raw, real-world “analog” information that consists of basic facts and figures. Computer data 150 includes different forms of data, such as numerical data, images, coding, notes, and financial data. Computer data 150 may originate at communication device 101 or be retrieved from a remote device via communications subsystem 116. Communication device 101 may store, modify, present, or transmit computer data 150 such as photographic images 114 and anonymized photographic images 124. Computer data 150 may be organized in one of a number of different data structures. Common examples of computer data 150 include video, graphics, text, and images. Computer data 150 can also be in other forms of flat files, databases, and other data structures.

Data storage subsystem 126 of communication device 101 includes data storage device(s). Controller 120 is communicatively connected, via system interlink 130, to data storage device(s). Data storage subsystem 126 provides program code 134 and computer data 150 stored on nonvolatile storage that is accessible by controller 120. For example, data storage subsystem 126 can provide a selection of program code 134 and computer data 150. These applications can be loaded into memory subsystem 112 for execution/processing by controller 120. In one or more embodiments, data storage device(s) can include hard disk drives (HDDs), optical disk drives, and/or solid-state drives (SSDs), etc. Data storage subsystem 126 of communication device 101 can include removable storage device(s) (RSD(s)), which is received in an RSD interface. Controller 120 is communicatively connected to the RSDs, via system interlink 130 and the RSD interface. In one or more embodiments, the RSDs are a non-transitory computer program product or computer readable storage device that may be executed by a processor associated with a user device such as communication device 101. Controller 120 can access the data storage device(s) or the RSDs to provision communication device 101 with program code 134 and computer data 150.

I/O subsystem 128 may include input devices 160 such as image capturing device(s) 110 and microphone 162. Input devices 160 may include touch input devices (e.g., screens, keys or buttons). I/O subsystem 128 may include output devices 164 such as first integral displays 106 and audio output devices 166.

In one or more embodiments, controller 120, via communications subsystem 116, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 116 includes a global positioning system (GPS) module that receives GPS broadcasts from GPS satellites to obtain geospatial location information. In one or more embodiments, controller 120, via communications subsystem 116, communicates via a wireless local area network (WLAN) link using one or more IEEE 802.11 WLAN protocols with an access point. In one or more embodiments, controller 120, via communications subsystem 116, may communicate via an OTA cellular connection with radio access networks (RANs). In an example, communication device 101, via communications subsystem 116, connects via RANs of a terrestrial network that is communicatively connected to a network server. Communication device 101 may be communicatively coupled to second device(s) 118 over one or more wired or wireless links 168.

In one or more embodiments, prior to anonymizing at least one human subject 122a-122b, controller 120 presents anonymization controls 172 on first display 106a. Controller 120 anonymizes at least one human subjects 122a-122b in response to receiving an input to anonymization controls 172 that indicates at least one human subject 122a-122b (e.g., human subject 122b that is third person 108c) to anonymize from photographic image(s) 114. In an example, anonymization controls 172 include thumbnail gallery 174 to retrieve and present compressed versions of photographic image(s) 152 stored at communication device 101a for selection. Anonymization controls 172 may include anonymize humans control 176 to select anonymizing any shape recognized as being a human shape such as by using AI modules 133. Anonymization controls 172 may include anonymize specified human subjects 178 to select anonymizing any human shape having facial biometric characteristics identified as a specific human subject to be anonymized such as by using AI modules 133. When anonymize specified human subjects 178 is selected, triggering human subject selection control 180 adds a specific human subject (e.g., second human subject 122b) to one or more human subjects indicated for anonymization. Anonymization controls 172 may include anonymize unspecified human subjects 182 to select anonymizing any human shape having facial biometric characteristics not identified as a specific human subject such as by using AI modules 133. When anonymize unspecified human subjects 182 is selected, triggering human subject selection control 180 adds a specific human subject (e.g., second human subject 122b) to one or more human subjects indicated for being presented in private mode while unspecified human subjects are anonymized. When none of the anonymization settings (176, 178 and 182) are selected, anonymization mode is deactivated. Anonymization controls 172 may include present at second display control 184 that triggers presentation of photographic image(s) 152 or anonymized photographic image(s) 153 at second display 119 using the currently selected anonymization mode.

FIG. 2B is a diagram of communication device 101 presenting the private version of photographic image(s) 152 while sending anonymized photographic image(s) 153 over communication environment 100 to second device118a, for presentation on second display119a. In an example, communication environment 100 includes or functions as media sharing network 202. In an example, communication device 101 distributes anonymized photographic image(s) 153 by communicatively connecting via network node 203 (e.g., wired, wireless, or cellular node) and data network 205 to second device 118a. Second person 108b is viewing a user interface of communication application 144, which is executed by second device 118a, that facilitates receiving anonymized photographic image(s) 153 and presenting anonymized photographic image(s) 153 on second display 119a.

FIG. 2C is a diagram of communication device 101 indirectly communicating anonymized photographic image(s) 153 with second device 118b by communicatively connecting to social media system 207. Fourth person 108d views a user interface of social media application 145 executed by second device 118b that communicatively connects to social media system 207 to retrieve anonymized photographic image(s) 153 that are presented on second display 219b.

With reference to FIGS. 2B-2C, controller 120 (FIG. 1) presents controls on first integrated display 106a that include private mode control 211 to trigger image anonymizing application 136 (FIG. 1), communication control 213 to trigger communication application 144 (FIG. 1), and social media control 215 to trigger social media application 145 (FIG. 1). Anonymizing user interface 217, which is available in private mode, may present controls such as: (i) select control 219 to select photograph image(s) 152 available on communication device 101; (ii) download control 221 to retrieve photograph image(s) 152 external to communication device 101; (iii) a human subject selection control 223 to identify a person to be specifically anonymized; (iv) anonymize control 225 to trigger anonymization of photograph image(s) 152 that are currently selected; and (v) upload control 227 to indicate anonymized photographic image(s) 153 may be transmitted by communication device 101.

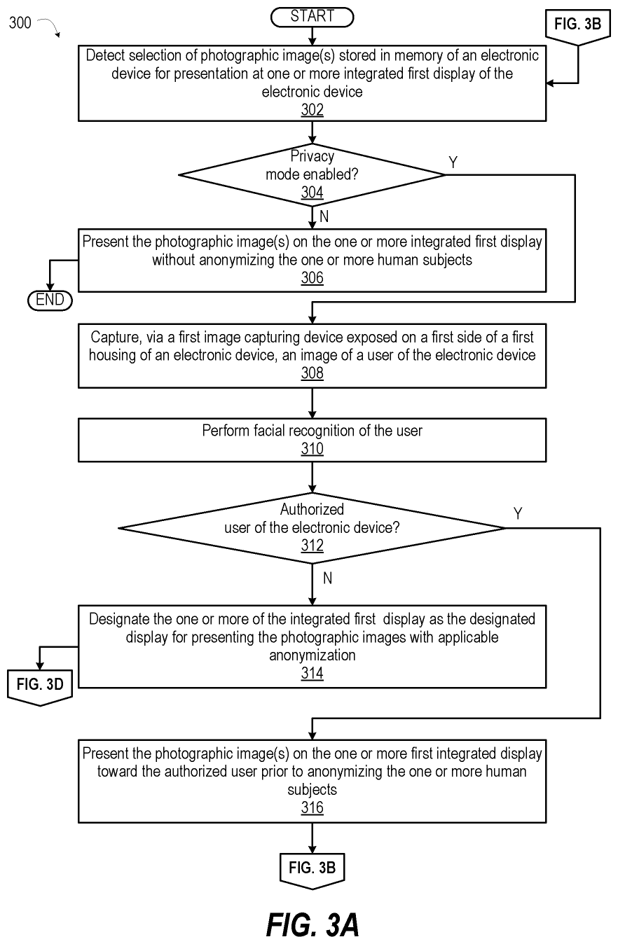

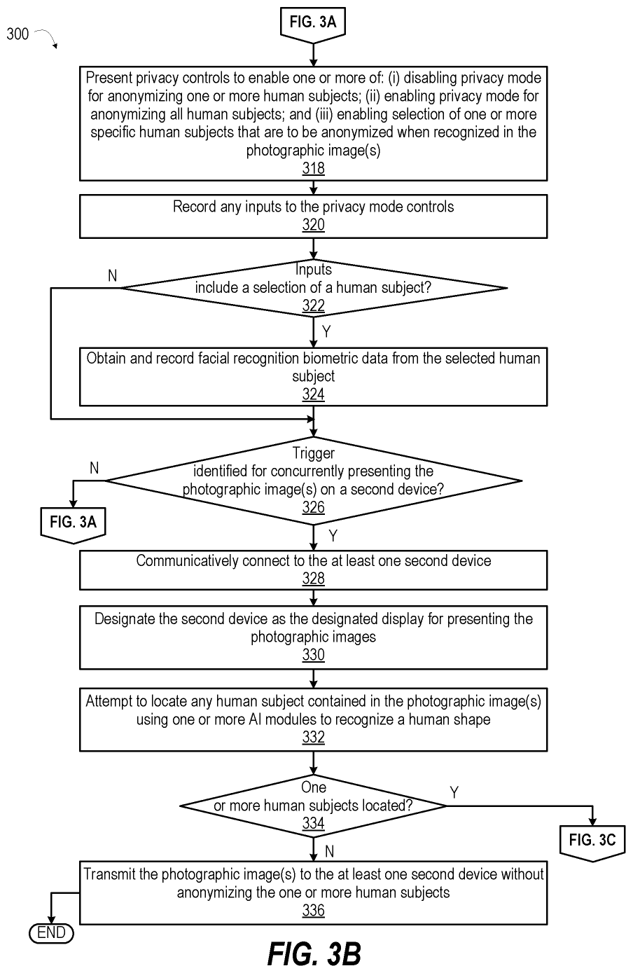

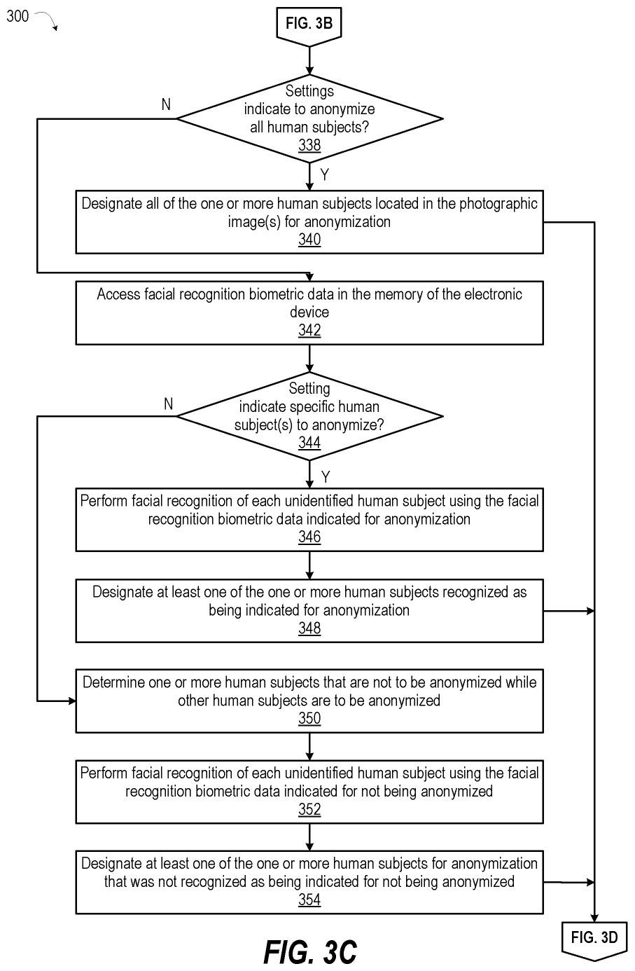

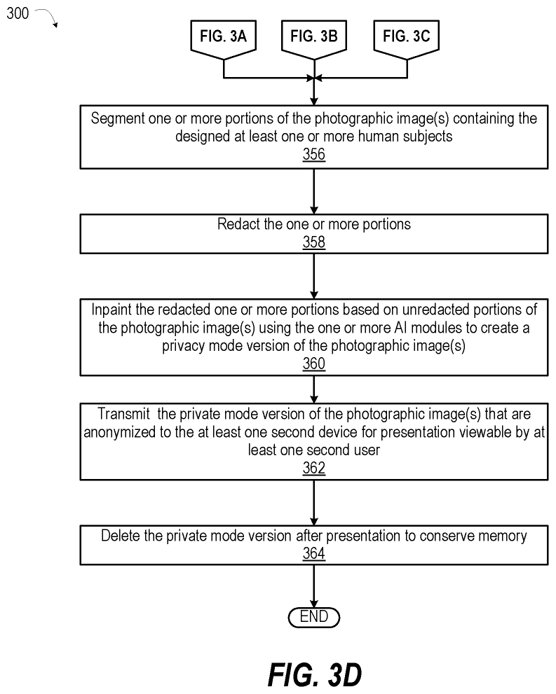

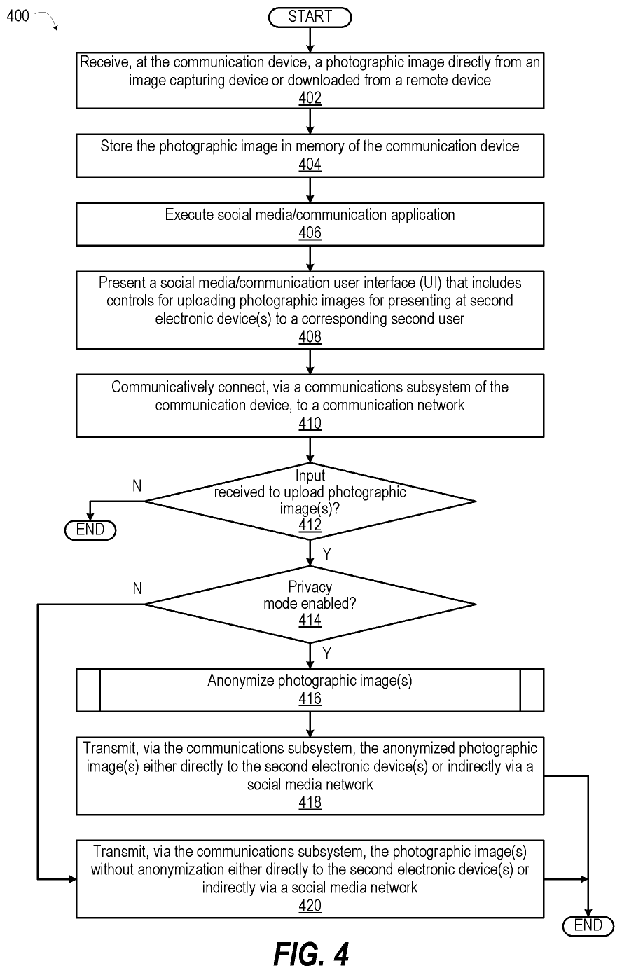

FIGS. 3A-3D (collectively “FIG. 3”) are a flow diagram presenting method 300 for automatically generating anonymized versions of photographic image(s) that are being shared for presentation on a secondary device. FIG. 4 is a flow diagram presenting method 400 for automatically anonymizing photographic images by an electronic device that are shared with a second electronic device via a social media system. The descriptions of method 300 and method 400 are provided with general reference to the specific components illustrated within the preceding FIGS. 1 and 2A-2C. Specific components referenced in method 300 and method 400 may be identical or similar to components of the same name used in describing preceding FIGS. 1 and 2A-2C. In one or more embodiments, controller 120 (FIG. 1) configures communication device 101 (FIG. 1) or a similar computing device to provide the described functionality of method 300 and method 400.

With reference to FIG. 3A, in one or more embodiments, method 300 includes detecting selection of photographic image(s) stored in memory of an electronic device for presentation at one or more first integrated display of the electronic device (block 302). Method 300 includes determining whether privacy mode is enabled (decision block 304). In response to determining that privacy mode is not enabled (i.e., is disabled), method 300 includes presenting the one or more photographic images on the one or more integrated first display without anonymizing the one or more human subjects (block 306). Then method 300 ends. Method 300 includes capturing, via a first image capturing device exposed on a first side of a first housing of an electronic device, an image of a user of the electronic device (block 308). Method 300 includes performing facial recognition of the user (block 310). Method 300 includes determining whether the user is recognized as an authorized user of the electronic device (decision block 312). In response to determining that the user is not an authorized user, method 300 includes designating the selected one or more of the integrated first display and the second device as designated displays for presenting the photographic images with applicable anonymization (block 314). Then method 300 proceeds to block 354 (FIG. 3D). In response to determining that the user is an authorized user, method 300 includes presenting the one or more photographic images on the first display toward the authorized user prior to anonymizing the one or more human subjects (block 316). Then method 300 proceeds to block 318 (FIG. 3B).

With reference to FIG. 3B, in one or more embodiments, method 300 includes presenting privacy controls on a display of the device to enable one or more of: (i) disabling privacy mode for anonymizing one or more human subjects; (ii) enabling privacy mode for anonymizing all human subjects; and (iii) enabling selection of one or more specific human subjects that are to be anonymized when recognized in the one or more photographic images (block 318). In one or more embodiments, the presentation of the privacy controls can occur as a camera, gallery, or device setting features that does not require the specific image be presented at the time of the user setting. Thus, for example, the user can enter the camera or gallery settings on the communication device and select, within an image sharing privacy settings (ISPS) user interface, specific persons to make private and/or to anonymize when sharing or presenting photographic images. The camera and/or gallery ISPS UI can include additional settings to support other features, such as entry of a list of authorized users who have permission to view the private image, toggling the device's image sharing privacy mode on or off, etc.

Returning to FIG. 3B, method 300 includes recording any inputs to the privacy mode controls (block 320). Method 300 includes determining whether the inputs to the privacy mode controls include a selection of a human subject in the one or more photographic images (decision block 322). In response to determining that the inputs to the privacy controls include a selection of a human subject in the one or more photographic images, method 300 includes obtaining and recording facial recognition biometric data from the selected human subject (block 324). In response to determining that the inputs to the privacy mode controls do not include a selection of a human subject in the one or more photographic images in decision block 322 or after block 324, method 300 includes determining whether a trigger is identified for concurrently presenting the one or more photographic images on a second device (decision block 326). In response to determining that the trigger is not identified for presenting the one or more photographic images on a second device, method 300 returns to block 302 (FIG. 3A). In response to determining that the trigger is identified for presenting the one or more photographic images concurrently on a second device, method 300 includes communicatively connecting to the at least one second device (block 328). Method 300 includes designating the second device as the designated display for presenting the photographic images (block 330). Method 300 includes attempting to locate any human subject contained in the photographic image(s) using one or more AI modules to recognize a human shape (block 332). The AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Method 300 includes determining whether one or more human subjected are located (decision block 334). In response to determining that one or more human subjected are not located, method 300 includes transmitting the one or more photographic images to the at least one second device without anonymizing the one or more human subjects (block 336). Then method 300 ends. In response to determining that one or more human subjected are located, method 300 proceeds to block 338 (FIG. 3C).

With reference to FIG. 3C, method 300 includes determining whether settings indicate to anonymize all human subjects (decision block 338). In response to determining that settings indicate to anonymize all human subjects, method 300 includes designating all of the one or more human subjects located in the photographic image(s) for anonymization (block 340). Then method 300 proceeds to block 356 (FIG. 3D). In response to determining that settings do not indicate to anonymize all human subjects, method 300 includes accessing facial recognition biometric data in the memory of the electronic device (block 342). Method 300 includes determining whether the settings indicate specific one or more human subjects to anonymize (decision block 344). In response to determining that the settings indicate specific one or more human subjects to anonymize, method 300 includes performing facial recognition of each unidentified human subject using the facial recognition biometric data indicated for anonymization (block 346). Method 300 includes designating at least one of the one or more human subjects recognized as being indicated for anonymization (block 348). Then method 300 proceeds to block 356 (FIG. 3D). In response to determining that the settings do not indicate specific one or more human subjects to anonymize, method 300 includes determining one or more human subjects that are not to be anonymized while other human subjects are to be anonymized (block 350). Method 300 includes performing facial recognition of each unidentified human subject using the facial recognition biometric data indicated for not being anonymized (block 352). Method 300 includes designating at least one of the one or more human subjects for anonymization that was not recognized as being indicated for not being anonymized (block 354). Then method 300 proceeds to block 356 (FIG. 3D).

With reference to FIG. 3D, method 300 includes segmenting one or more portions of the one or more photographic images containing the one or more human subjects (block 356). Method 300 includes redacting the one or more portions corresponding to the human subjects to be anonymized (block 358). Method 300 includes inpainting the redacted one or more portions based on unredacted surrounding portions of the one or more photographic images using the one or more AI modules to create a privacy mode version of the one or more photographic images (block 360). In one or more embodiments, the AI modules support “magic eraser” functionality that can locate, identify, and remove at least one human subject with an AI-generated replacement background to camouflage the removed human subject(s). Method 300 includes transmitting the private mode version of the one or more photographic images that are anonymized to the at least one second device for presentation viewable by at least one second user (block 362). Method 300 includes deleting the private mode version after presentation is concluded to conserve memory (block 364). Then method 300 ends.

With reference to FIG. 4, method 400 includes receiving, at the communication device, a photographic image directly from an image capturing device or downloaded from a remote device (block 402). Method 400 includes storing the photographic image in memory of the communication device (block 404). Method 400 includes executing social media/communication application (block 406). Method 400 includes presenting a social media/communication user interface (UI) that includes controls for uploading photographic images for presenting at second electronic device(s) to a corresponding second user (block 408). Method 400 includes communicatively connecting, via a communications subsystem of the communication device, to a communication network (block 410). Method 400 includes determining whether an input is received to upload photographic image(s) (decision block 412). In response to determining that an input is not received to upload photographic image(s), method 400 ends. In response to determining that an input is received to upload photographic image(s), method 400 includes determining whether privacy mode is enabled (decision block 414). In response to determining that privacy mode is enabled, method 400 includes anonymizing the photographic image(s) (block 416). An example of anonymization is provided in method 300 of FIG. 3. In response to determining that privacy mode is not enabled in decision block 414 or after block 416, method 400 includes transmitting, via the communications subsystem, the anonymized photographic image(s) either directly to the second electronic device(s) or indirectly via a social media network (block 418). Method 400 then ends.

In one or more embodiments, method 400 may further include accessing a memory that stores one or more photographic images. Method 400 may further include connecting a communications subsystem of an electronic device to one or more second devices having at least one second display. Method 400 may further include presenting, to an authorized user of the electronic device, the one or more photographic images on a first integrated display of at least one first integrated display of the electronic device. In response to a trigger to present the one or more photographic images on a second display of the at least one second display while an image display function of the electronic device is set to a privacy mode, method 400 may further include recognizing one or more human subjects in the one or more photographic images. Method 400 may further include anonymizing the one or more human subjects in a private mode version of the one or more photographic images. Method 400 may further include presenting the private mode version of the one or more photographic images on the second display.

In one or more embodiments, in recognizing the one or more human subjects, method 400 may further comprise performing facial recognition of the one or more human subjects based on facial recognition data stored in the memory for one or more persons. Method 400 may further include anonymizing the one or more human subjects by selectively anonymizing an identified person designated for privacy mode. Other persons not identified for privacy mode are left visible within the private mode version of the one or more photographic images.

In one or more embodiments, method 400 may further include monitoring a first image capturing device exposed on a first side of a device housing of the electronic system. The first integrated display is exposed on the first side. Method 400 may further include capturing, via the first image capturing device, an image of a user of the electronic device. Method 400 may further include performing facial recognition of the user. Method 400 may further include presenting the one or more photographic images on the first integrated display without anonymization in response to identifying the authorized user of the electronic device based on the facial recognition.

In one or more embodiments, prior to anonymizing the one or more human subjects, method 400 may further include presenting anonymization controls on the first integrated display. Method 400 may further include anonymizing the one or more human subjects in response to receiving an input to the anonymization controls that indicates which of the one or more human subjects to anonymize from the one or more photographic images.

In one or more embodiments, method 400 may further include executing a universal device controller application stored in the memory to configure the communications subsystem to support a communication exchange with the at least one second device, which executes a universal device controller client. Method 400 may further include triggering, via the communication exchange, the at least one second device to present the private mode version of the one or more photographic images on the second display.

In one or more embodiments, method 400 may further include connecting the communications subsystem to the one or more second devices having the at least one second display by connecting the electronic device via a wireless or wired networking interface to an external monitor.

In one or more embodiments, method 400 may further include connecting the communications subsystem to the one or more second devices by transferring media to a media sharing network that is accessible by the one or more second devices. Method 400 may further include identifying the trigger to present the one or more photographic images on the second display based on a control input to transfer the one or more photographic images to the media sharing network.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one first integrated display;
a memory that stores one or more photographic images;
a communications subsystem configurable to connect the electronic device to one or more second devices having at least one second display; and
a controller communicatively connected to the memory and the communications subsystem, and which:
presents, to an authorized user of the electronic device, the one or more photographic images on a first integrated display of the at least one first integrated display; and
in response to a trigger to present the one or more photographic images on a second display of the at least one second display while an image display function of the electronic device is set to a privacy mode:
recognizes one or more human subjects in the one or more photographic images;
anonymizes the one or more human subjects in a private mode version of the one or more photographic images; and
presents the private mode version of the one or more photographic images on the second display.

2. The electronic device of claim 1, wherein, in anonymizing the one or more human subjects, the controller:
segments one or more portions of the one or more photographic images containing the one or more human subjects;
redacts the one or more portions; and
inpaints the redacted one or more portions based on unredacted portions of the one or more photographic images.

3. The electronic device of claim 1, wherein:
in recognizing the one or more human subjects, the controller:
performs facial recognition of the one or more human subjects based on facial recognition data stored in the memory for one or more persons; and
to anonymize the one or more human subjects, the controller selectively anonymizes an identified person designated for privacy mode, while other persons not identified for privacy mode are left visible within the private mode version of the one or more photographic images.

4. The electronic device of claim 1, further comprising a device housing and at least one image capturing device communicatively coupled to the controller and comprising a first image capturing device exposed on a first side of a device housing, and wherein the controller:
captures, via the first image capturing device, an image of a user of the electronic device;
performs facial recognition of the user; and
presents the one or more photographic images on the first integrated display without anonymization in response to identifying the authorized user of the electronic device based on the facial recognition.

5. The electronic device of claim 1, wherein the controller, prior to anonymizing the one or more human subjects:
presents anonymization controls on the first integrated display; and
anonymizes the one or more human subjects in response to receiving an input to the anonymization controls that indicates the one or more human subjects to anonymize from the one or more photographic images.

6. The electronic device of claim 1, wherein:
the memory stores a universal device controller application;
each of the at least one second device has a corresponding second memory with a universal device controller client stored therein; and
the controller:
executes the universal device controller application to configure the communications subsystem to support a communication exchange with the at least one second device, which executes the universal device controller client; and
triggers, via the communication exchange, the at least one second device to present the private mode version of the one or more photographic images on the second display.

7. The electronic device of claim 1, wherein the communications subsystem comprises a wireless or wired networking interface connectable to the at least one second device comprising an external monitor.

8. The electronic device of claim 1, wherein:
the communications subsystem is configurable to connect the electronic device to the one or more second devices by transferring media to a media sharing network that is accessible by the one or more second devices; and
the controller identifies the trigger to present the one or more photographic images on the second display based on a control input to transfer the one or more photographic images to the media sharing network.

9. A method comprising:
accessing a memory that stores one or more photographic images;
connecting a communications subsystem of an electronic device to one or more second devices having at least one second display;
presenting, to an authorized user of the electronic device, the one or more photographic images on a first integrated display of at least one first integrated display of the electronic device; and
in response to a trigger to present the one or more photographic images on a second display of the at least one second display while an image display function of the electronic device is set to a privacy mode:
recognizing one or more human subjects in the one or more photographic images;
anonymizing the one or more human subjects in a private mode version of the one or more photographic images; and
presenting the private mode version of the one or more photographic images on the second display.

10. The method of claim 9, wherein anonymizing the one or more human subjects comprises:
segmenting one or more portions of the one or more photographic images containing the one or more human subjects;
redacting the one or more portions; and
inpainting the redacted one or more portions based on unredacted portions of the one or more photographic images.

11. The method of claim 9, wherein recognizing the one or more human subjects comprises:
performing facial recognition of the one or more human subjects based on facial recognition data stored in the memory for one or more persons; and
anonymizing the one or more human subjects by selectively anonymizes an identified person designated for privacy mode, while other persons not identified for privacy mode are left visible within the private mode version of the one or more photographic images.

12. The method of claim 9, further comprising:
monitoring at least one image capturing device comprising a first image capturing device exposed on a first side of a device housing of the electronic device, the first integrated display exposed on the first side;
capturing, via the first image capturing device, an image of a user of the electronic device;
performing facial recognition of the user; and
presenting the one or more photographic images on the first integrated display without anonymization in response to identifying the authorized user of the electronic device based on the facial recognition.

13. The method of claim 9, further comprising:
prior to anonymizing the one or more human subjects:
presenting anonymization controls on the first integrated display; and
anonymizing the one or more human subjects in response to receiving an input to the anonymization controls that indicates the one or more human subjects to anonymize from the one or more photographic images.

14. The method of claim 9, further comprising:
executing a universal device controller application stored in the memory to configure the communications subsystem to support a communication exchange with the at least one second device, which executes a universal device controller client; and
triggering, via the communication exchange, the at least one second device to present the private mode version of the one or more photographic images on the second display.

15. The method of claim 9, wherein connecting the communications subsystem to the one or more second devices having the at least one second display comprises connecting the electronic device via a wireless or wired networking interface to an external monitor.

16. The method of claim 9, further comprising:
connecting the communications subsystem to the one or more second devices by transferring media to a media sharing network that is accessible by the one or more second devices; and
identifying the trigger to present the one or more photographic images on the second display based on a control input to transfer the one or more photographic images to the media sharing network.

17. A computer program product comprising:
a computer readable storage device; and
program code on the computer readable storage device that when executed by a processor associated with an electronic device, the program code enables the electronic device to provide functionality of:
accessing a memory that stores one or more photographic images;
connecting a communications subsystem of an electronic device to one or more second devices having at least one second display;
presenting, to an authorized user of the electronic device, the one or more photographic images on a first integrated display of at least one first integrated display of the electronic device; and
in response to a trigger to present the one or more photographic images on a second display of the at least one second display while an image display function of the electronic device is set to a privacy mode:
recognizing one or more human subjects in the one or more photographic images;
anonymizing the one or more human subjects in a private mode version of the one or more photographic images; and
presenting the private mode version of the one or more photographic images on the second display.

18. The computer program product of claim 17, wherein the program code enables the electronic device to provide functionality of anonymizing the one or more human subjects by:
segmenting one or more portions of the one or more photographic images containing the one or more human subjects;
redacting the one or more portions; and
inpainting the redacted one or more portions based on unredacted portions of the one or more photographic images.

19. The computer program product of claim 17, wherein the program code enables the electronic device to provide functionality of recognizing the one or more human subjects by:
performing facial recognition of the one or more human subjects based on facial recognition data stored in the memory for one or more persons; and
anonymizing the one or more human subjects by selectively anonymizes an identified person designated for privacy mode, while other persons not identified for privacy mode are left visible within the private mode version of the one or more photographic images.

20. The computer program product of claim 17, wherein the program code enables the electronic device to provide functionality of:
monitoring at least one image capturing device comprising a first image capturing device exposed on a first side of a device housing of the electronic device, the first integrated display exposed on the first side;
capturing, via the first image capturing device, an image of a user of the electronic device;
performing facial recognition of the user; and
presenting the one or more photographic images on the first integrated display without anonymization in response to identifying the authorized user of the electronic device based on the facial recognition.
